(19) United States
(12) Patent Application Publication
(10) Pub. No.: US 2016/0113435 A1
(43) Pub. Date: Apr. 28, 2016

(54) METHOD, INFUSION ASSEMBLY, AND CARTRIDGE FOR THE PREPARATION OF A LIQUID PRODUCT

(71) Applicant: LUIGI LAVAZZA S.P.A., Torino (IT)

(72) Inventors: Alberto CABILLI, Torino (IT); Luca BUGNANO, Torino (IT); Fabio TOTTONE, Torino (IT)

(73) Assignee: Luigi Lavazza S.p.A., Torino (IT)

(21) Appl. No.: 14/892,136

(22) PCT Filed: Mar. 11, 2014
(86) PCT No.: PCT/IB2014/059618

§ 371 Date: Nov. 18, 2015

(30) Foreign Application Priority Data
May 21, 2013 (IT) TO2013A000404

(51) Int. Cl. A47J 31/40; A23F 5/26; B65D 85/804

(52) U.S. Cl. CPC A47J 31/407; B65D 85/8043; A23F 5/262

(57) ABSTRACT

A method for the preparation of a liquid product such as coffee by means of hot liquid and/or steam introduced into a cartridge (10) containing a dose of ground coffee envisages introducing the hot liquid and/or steam into the cartridge (10) thus bringing about deformation of at least one portion (1420) of a bottom (142) of the cartridge (10) and consequent perforation of the aforesaid bottom (142) by an array of perforating tips (10). The cartridge (10) is set with the bottom (142) facing the array of perforating tips (10) but at a distance therefrom so that the bottom (142), by undergoing deformation, comes into contact with the array of perforating tips (10) with a delay with respect to the start of the action of introduction of the aforesaid hot liquid and/or steam into the cartridge (10).

### TECHNICAL FIELD

The present disclosure regards the preparation of liquid products.

One or more embodiments may refer to the preparation of beverages, such as for example coffee.

### TECHNOLOGICAL BACKGROUND

Cartridges (also referred to as “capsules”) for the preparation of liquid products, such as for example beverages, via introduction of liquid (possibly under pressure and/or at high temperature) and/or steam, constitute a technological sector that is extremely rich and articulated, as documented, for example, by the documents Nos. FR-A-757 358, FR-A-2 373 999 (which corresponds to U.S. Pat. No. 4,136,202), FR-A-2 556 323, GB-A-938 617, GB-A-2 023 086, CH-A-406 561, U.S. Pat. No. 3,403,617, U.S. Pat. No. 3,470,812, U.S. Pat. No. 3,607,297 (which corresponds to FR-A-1 537 031), WO-A-86/02 537, EP-A-0 199 953, EP-A-0 211 511, EP-A-0 242 556, EP-A-0 468 078, EP-A-0 469 162, EP-A-0 507 905, EP-A-1 295 554, EP-A-1 886 942, EP-A-2 218 653, and WO-A-2010/106516.

A fair number of the solutions described in the documents cited regards primarily the preparation of liquid products constituted by beverages such as coffee, tea, chocolate, broths, soups, or infusions of various sorts.

Amongst the above documents, the document No. EP-A-0 507 905, taken as model for the preamble of claim 1, describes solutions that can be used for preparing espresso coffee, whereas the document No. EP-A-1 886 942 describes a cartridge, the contents of which, in particular ground coffee, have been mechanically compacted. Again, documents such as for example EP-A-1 295 554 describe an infusion device comprising an infusion chamber designed to receive the cartridge and within which filtering tips are installed, on the side where the coffee comes out.

### OBJECT AND SUMMARY

Over the years, the preparation of beverages according to the criteria described previously has become one of the current forms of preparation of beverages, such as coffee, both in the domestic environment and in the context of communities, as well as in catering activities of a commercial type.

The situation described above determines an incentive for a further improvement of the characteristics of the product that can be obtained.

The object of one or more embodiments is to contribute to the aforesaid further qualitative improvement.

In one or more embodiments, the above object is achieved thanks to a method having the characteristics recalled specifically in the ensuing claims.

One or more embodiments refer also may to a corresponding infusion assembly and to a corresponding cartridge (or capsule, as it is sometimes referred to).

The claims form an integral part of the technical teaching provided herein in relation to the embodiments.

### BRIEF DESCRIPTION OF THE FIGURES

One or more embodiments will now be described, purely by way of non-limiting example, with reference to the annexed drawings, wherein:

FIG. 1 is a general perspective view of a cartridge for the preparation of liquid products;

FIG. 2 is a schematic illustration of general criteria of use of such a cartridge;

FIGS. 3 and 4 are schematic illustrations of embodiments and their modalities of use;

FIGS. 5 and 6 illustrate variant embodiments and their modalities of use; and

FIG. 7 is a general scheme of a machine comprising an infusion assembly according to the embodiments.

### DETAILED DESCRIPTION

In the ensuing description, various specific details are illustrated aimed at providing an in-depth understanding of examples of one or more embodiments. The embodiments may be obtained without one or more of the specific details, or with other methods, components, materials, etc. In other cases, known structures, materials, or operations are not illustrated or described in detail so that various aspects of the embodiments will not be obscured.

Reference to “one or more embodiments” within the framework of the present description is intended to indicate that a particular configuration, structure, or characteristic described in relation to the embodiment is comprised in at least one embodiment. Hence, any possible reference to “an embodiment” or “one embodiment” that may be present in various points of the present description, does not necessarily refer to one and the same embodiment. Furthermore, particular conformations, structures or characteristics may be combined in any adequate way in one or more embodiments.

The references used herein are merely designed to facilitate reading and hence do not define the sphere of protection or the scope of the embodiments.

In the figures, the reference number 10 designates as a whole a cartridge (also referred to as “capsule”) for the preparation of a liquid product via introduction of hot liquid and/or steam into the cartridge.

In one or more embodiments, the liquid product in question may be a beverage, such as for example coffee (for instance, espresso coffee) obtained by introducing into the cartridge 10 liquid and/or steam under pressure and at a high temperature (i.e., hot). The repeated reference, in the framework of the present detailed description, to the preparation of the beverage coffee is on the other hand not to be understood as in any way limiting the scope of the description, which is altogether general.

The cartridge 10 contains a dose 12 (represented for simplicity of illustration only in FIG. 2) of at least one substance that can form the aforesaid liquid product (e.g., a beverage such as coffee) using the aforesaid liquid and/or steam.

In one or more embodiments, the dose 12 may comprise ground coffee or some other precursor of a liquid product, such as for example a beverage.

In one or more embodiments, the cartridge 10 may substantially have the shape of a tray or a cup where the dose 12 is present and may comprise:
a body 14, with a side or peripheral wall 140 and a bottom wall 142 that closes the body 14 at one end of the side wall 140; and
a sealing foil 16 that closes the cartridge 10 at the opposite end with respect to the bottom wall 142.

In one or more embodiments, the foil 16 may be plane and/or be designed to be connected in a sealed way, for example by heat sealing, to the side wall 140 of the body 14 in the cartridge, for example in a position corresponding to a flange 144 that surrounds the mouth part of the body 14.

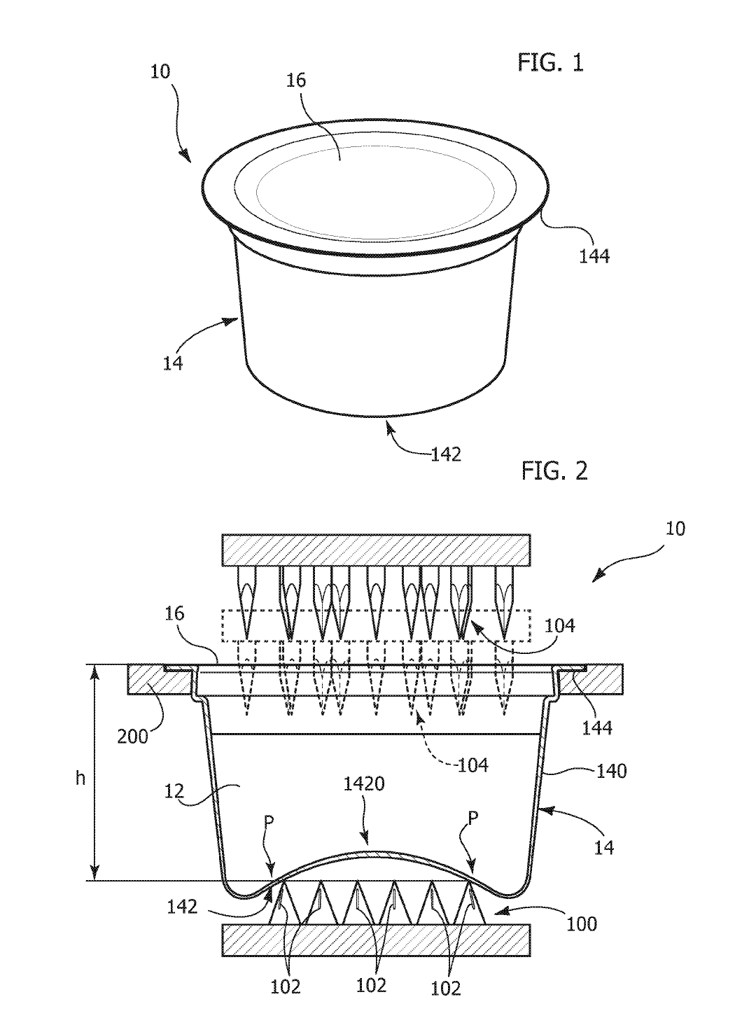

In one or more embodiments, as represented in FIG. 1, the body 14 may be shaped like a tray, with mutually parallel opposite end surfaces, that for example diverges from the bottom wall 142 to the end closed by the sealing foil 16. In one or more embodiments, this diverging conformation may be frustoconical as exemplified herein. This conformation is not on the other hand imperative in so far as the cartridge 14 could present different shapes; for example, it may be prismatic, frustopyramidal, etc.

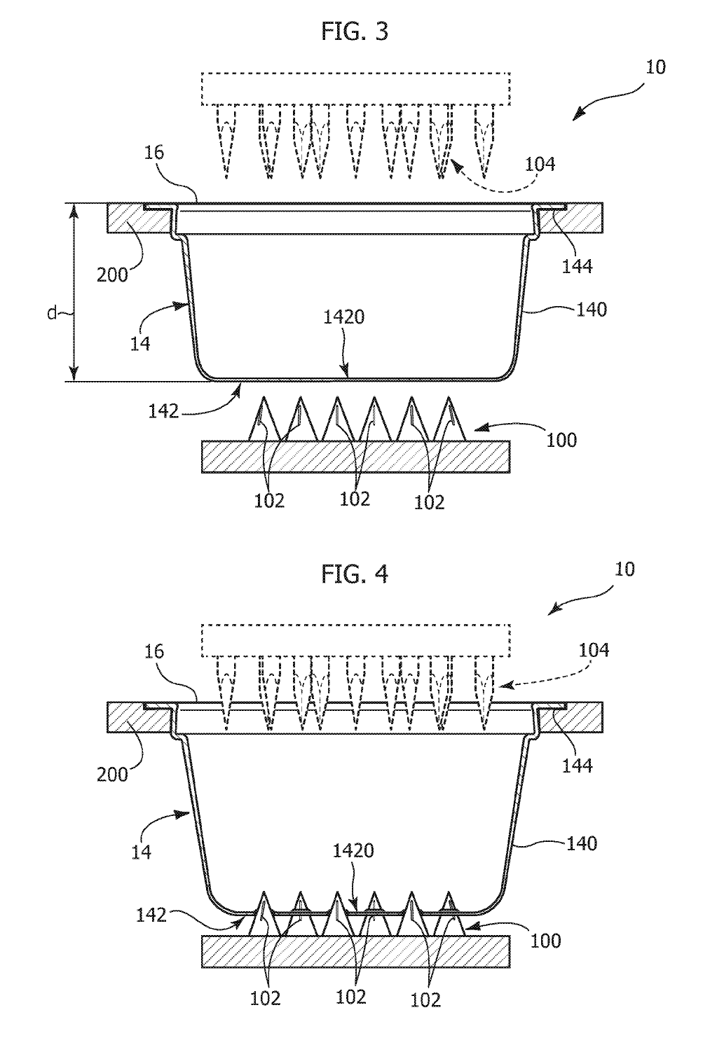

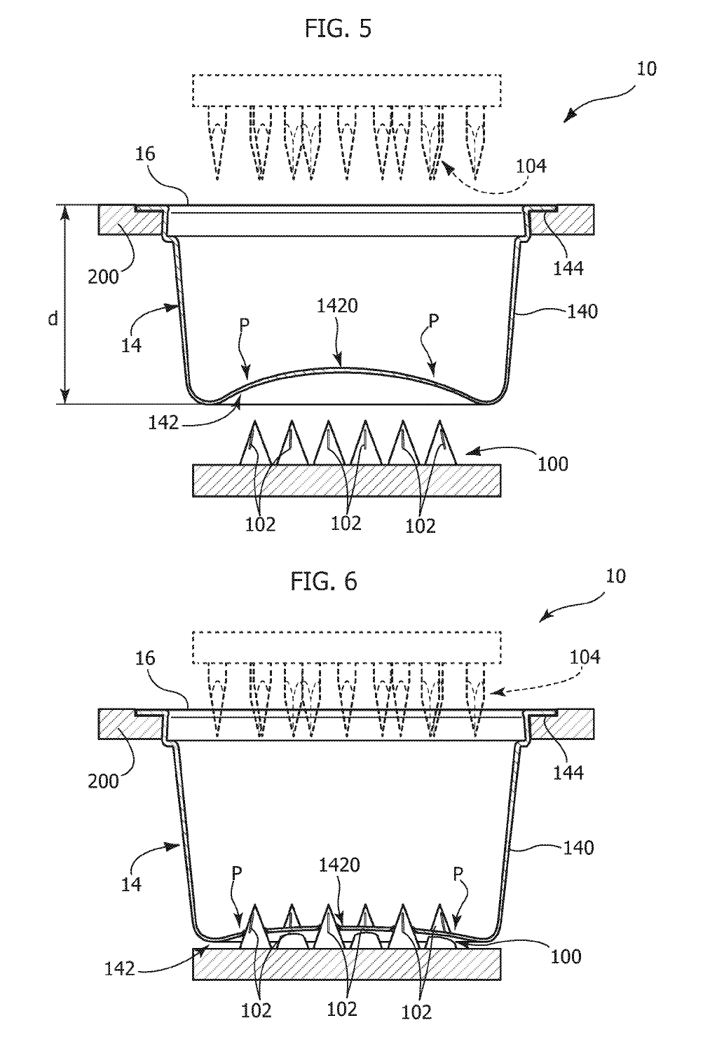

In one or more embodiments, the bottom wall 142 may have either an overall plane conformation (see for example FIGS. 3 and 4, to which we shall return in what follows) or be shaped like a concave vault (as illustrated in FIG. 2 and in FIGS. 5 and 6), for instance, with the concavity facing towards the outside of the cartridge 10.

FIG. 2 illustrates in brief the modalities of use of a cartridge 10 according to criteria that can substantially be likened to the ones described in the document No. EP-A-0 507 905, already cited previously.

As schematically represented in FIG. 2, the cartridge 10 is brought to rest-i.e., into contact-on an array of tips (bottom tips) 100. The tips 100 may have, for example, a hollow structure, substantially resembling that of the needle of a syringe, with one or more openings 102 designed to enable outflow of the liquid product prepared using the cartridge 10.

According to the modalities of use referred to in the document No. EP-A-0 507 905, when the cartridge 10 is resting on the bottom tips 100, the bottom 142 rests on the tips 100.

At the same time, the top foil 16 of the cartridge 10 is exposed to, i.e., set facing, another array of tips (top tips) 104 that are to perforate the sealing foil 16 of the cartridge.

In the method of preparation of the beverage (such as coffee, e.g., espresso coffee) the top tips 104 are made to drop down, as represented by the dashed lines in FIG. 2, so as to penetrate into the sealing foil 16, thus perforating it. In this way, the cartridge 16 is opened on its top side.

Through the holes made by the tips 104 in the top foil 16 there is then made to flow hot water (for example, supplied at a temperature in the region of 90-100° C. approximately).

As the hot water flows into the cartridge 10, it performs a dual function.

In the first place, it starts to penetrate into the dose 12 of ground coffee thus starting off the process (which may be identified, perhaps in a way not altogether proper, as “infusion process”) that leads to preparation of the beverage.

In the second place, the pressure that is set up within the cartridge 10 causes the bottom 142 to undergo deformation and to be pushed against the tips 100 on which the bottom wall 142 itself rests.

Initially, the tips 100 deform the bottom 142, creating therein dimples and subsequently start to perforate the bottom wall 142 of the cartridge 10 so that the coffee infusion starts to exit from the cartridge 10.

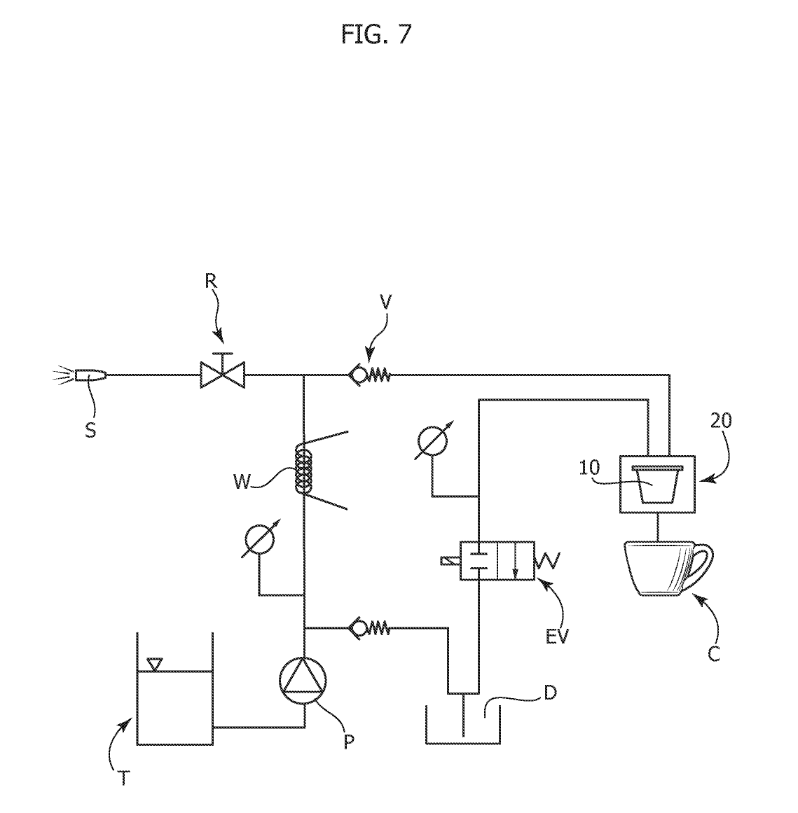

As already mentioned previously, the tips 100 may be hollow tips, resembling hypodermic needles, so that the coffee infusion can start to exit from the cartridge 10 passing through the openings 102 so as to flow into the cavities of the bottom tips 100, which lead to a duct for delivering the beverage for example into a suitable container for the beverage (see, for example, C in FIG. 7).

The mechanism for perforating the bottom wall 142 by the array of tips 100 proceeds until practically every one of the tips 100 has perforated the bottom wall 142 of the cartridge 10 and penetrated into the cartridge 10 itself so that the axial cavity of the tip provides a path of flow for delivery of the coffee infusion. This condition is maintained until preparation of the beverage is through, after which the pump that sends the hot water under pressure into the cartridge 10 is deactivated, the top tips 104 (if this has not already occurred previously) are recalled upwards, and the spent cartridge 10 can be extracted from the machine and replaced with a new cartridge to proceed to preparing a new coffee.

As has already been said, the general structure of the cartridge 10 and the general criteria of use just described with reference to FIG. 2 are to be deemed in themselves known (for example, from the document No. EP-A-0 507 905) and hence such as not to require a more detailed description herein.

For the present purpose, it may be noted that, to implement the modalities of use just described, the cartridge 10 is inserted into an infusion assembly comprising an infusion chamber having a height h that is identified by the distance that separates the array of bottom perforating tips 100 (more precisely the plane of lie of the vertices or crests of the tips 100) from the plane in which the hot liquid and/or steam are/is introduced into the cartridge.

The latter plane is practically the plane in which, during the process of preparation of the beverage, the sealing foil 16 is positioned and kept by the supporting elements 200, for example, a ring-shaped structure (whether continuous or discontinuous), which support the cartridge 10 in a position corresponding to the flange 144 on which the foil 16 is applied.

In various types of machines for the production of beverages with cartridges of the type exemplified herein, the position in which the cartridge 10 is located at the start of introduction of the hot liquid and/or steam into the cartridge may be different from the one in which the cartridge is initially introduced into the machine. In this case, the cartridge 10 starts from an initial condition that it occupies when it is introduced into the machine—where the overall height of the infusion chamber may be greater than the height h represented in the figures—and reaches only subsequently the position that it occupies at the start of introduction of the hot liquid and/or steam into the cartridge itself. This position is exemplified in FIG. 2 (and in FIGS. 3 and 5 described in what follows) and—as may be seen precisely in FIG. 2—is the same position that the cartridge 10 occupies when, following upon subsequent lowering of the tips 104, the foil 16 is perforated, enabling introduction of the hot liquid and/or steam).

In view of the foregoing (also for the purposes of an understanding of the annexed claims), the height h of the infusion chamber here considered may be defined as the distance between the plane of lie of the vertices or cusps of the tips of the array 100 and the plane of introduction of the hot liquid and/or steam into the cartridge 10: this plane can be identified precisely by the plane where the foil 16 is located at the moment when the step of introduction of the hot liquid and/or steam into the cartridge 10 starts (and not, possibly, in previous steps).

In the solution shown in FIG. 2, at the start of the process of introduction of the hot liquid and/or steam, the bottom 142 of the cartridge rests already on the tips 100 so that the process of perforation of the portion 1420 by the tips of the array 100 starts immediately at the start of the process of introduction of the hot liquid and/or steam, i.e., as soon as the hot liquid and/or steam start/starts to flow into the cartridge 10 through the foil 16 perforated by the top tips 104.

It has been noted that these modalities of use can give rise to conditions where the liquid product prepared and delivered is certainly of high quality but may still be further improved.

Albeit without wishing to be tied down to any specific theory in this regard, there is reason to believe that the above non-optimality is due to the fact that, if hot liquid and/or steam start/s to be introduced into the cartridge 10 when the bottom 142 thereof is already in contact with the array of perforating tips 104, the bottom starts to be perforated practically immediately, determining exit of the liquid produced (e.g., coffee) at pressures in the region of 0.5-2 bar.

One or more embodiments enable improved results to be achieved by resorting to embodiments as exemplified schematically in FIGS. 3 to 6.

The above embodiments are inspired the general criterion of introducing hot liquid or steam into the cartridge 10, bringing about deformation of the bottom 142 thereof, with consequent perforation of at least a portion 1420 of the bottom 142 itself by an array of perforating tips 100 facing the bottom 142.

One or more embodiments, as schematically exemplified in FIGS. 3 to 6, may, however, envisage that, when the hot liquid and/or steam in the cartridge 10 start/s to be introduced therein, the bottom 142 is facing the array of tips 100—but is kept at a certain distance therefrom. In this way, the bottom 142 of the cartridge 10, by undergoing deformation, comes into contact with the array of perforating tips 100 only subsequently, i.e., with a certain delay with respect to the start of the action of introduction of the liquid and/or steam into the cartridge.

One or more embodiments may envisage that the hot liquid and/or steam are/is introduced into the cartridge 10 at a pressure kept under control (e.g., via a pressure-modulation valve) at values in the region of 2-12 bar, optionally 5-8 bar.

The experiments conducted by the present applicant have shown that results that are altogether satisfactory as regards the aforesaid “delay” between introduction of the hot liquid and/or steam into the cartridge 10 and perforation of the bottom 142 by the array of tips 100 (which faces, but is initially kept at a distance from, the bottom of the cartridge) may be obtained when the material of the body 12 of the cartridge (or at least of the bottom part 142 subjected to deformation) is made of a material that can undergo significant deformation in the plastic region without tearing (hence preserving the possibility of being perforated in a regular way and without being broken/torn by the array of tips 100) at temperatures higher than 70° C., typically in the range between 70° C. and 200° C., optionally between 70° C. and 150° C.

In one or more embodiments, the material of the body 12 of the cartridge (or at least of the bottom part 142 subjected to deformation) may be chosen from among:
polypropylene co-extruded with EVOH;
polyethylene co-extruded with EVOH;
polystyrene co-extruded with EVOH;
combinations of the above;
polymers extracted from biomass (for example polysaccharides, such as starch—Mater-Bi®—cellulose, lipids, proteins);
synthetic polymers (e.g., polylactic acid—PLA—derived from fermentation of starch);
polymers produced by genetically modified micro-organisms or bacteria (e.g., polyhydroxy alkanoates—PHAs); and
polymers from fossil monomers (e.g., polybutylene succinate—PBS).

Also numbered in this category are mixtures of the above (the so-called compounds) and/or insertion of additives such as micro-/nano-particles (e.g., talcum, Cloisite®)

In one or more embodiments, the part of the bottom 142 subjected to deformation may have a thickness comprised between 50 and 700 μm.

One or more embodiments make it possible for perforation of the bottom 142 of the cartridge 10 to occur at a pressure of 2-4 bar without there being any structural yielding of the bottom itself.

In one or more embodiments, the combined effect of these mechanical, thermal, and hydraulic conditions, can enable the bottom 142 of the cartridge 10 to undergo “extrusion” gradually towards the array of tips 100 bringing about a condition of pre-infusion that is improved as compared to solutions as exemplified in FIG. 2, where the array of tips 100 is in contact with the bottom of the cartridge 10 (even) before start of the process of introduction of hot liquid and/or steam into the cartridge 10 itself.

The experiments conducted by the present applicant show that the effect of thus setting the array of tips 100 at a distance from the bottom 142 of the cartridge may improve the effect of pre-infusion.

Once again, albeit without wishing to be tied down to any specific theory in this connection, it has been found that—above all in the production of espresso coffee—the pre-infusion (i.e., the step in which the hot liquid and/or steam penetrate/s and diffuse/s in the dose 12 before the beverage starts to exit from the holes opened by the tips 100 in the bottom 142) can play an important role for the purposes of the final qualitative result: in fact, a fair number of the extracts are solubilized precisely during pre-infusion; prolongation of the time for pre-infusion may consequently improve the mixability between the hot liquid/steam (e.g., water/steam) and the dose (for example, ground coffee) thus increasing the extract.

One or more embodiments may achieve this prolongation via the plastic deformation that the bottom 142 of the cartridge 10 undergoes before reaching the condition of contact with the array of perforating tips 100, which are initially at a distance from the bottom 142 when this is in the undeformed condition. The evident physical effect of this phenomenon is that, at the end of delivery, the cartridge is “higher” than before delivery (i.e., before being introduced into the infusion assembly).

In one or more embodiments, the extent of the aforesaid initial distance between the bottom 142 and the array of tips 100 may be comprised between 1 mm and 6 mm, for example between 2 mm and 4 mm.

In the case of a bottom 142 with an initial plane conformation (FIG. 3), the distance in question may be defined as distance between the plane in which the vertices or cusps of the tips 100 lie and the general plane of lie of the bottom 142: it is, in other words, the plane that provides a position of stable rest of the cartridge once this is resting on a horizontal surface.

In embodiments in which the bottom 142 of the cartridge 10 has an initial concave conformation, with the concavity facing towards the outside of the cartridge 10 (FIG. 5), the ranges of values defined previously may be referred to the distance between the plane in which the vertices or cusps of the tips 100 lie and the plane of rest as defined above, in practice, the plane in which there extends the radially outer part of the bottom 142, which surrounds the concave part, where the portion 1420 that is to be perforated is located.

In one or more embodiments, control of the pressure of introduction of the hot liquid and/or steam, for example in the range 2 to 12 bar or, preferably, in the range 5 to 8 bar can mean that inside the cartridge 10 there is not created within a short time an excessively steep pressure ramp: this can prevent any uncontrolled deformation of the bottom 142 and enable a regular heating of the material constituting the bottom 142, thus enabling “extrusion” thereof towards the array of tips 100.

FIGS. 3 to 6 present some examples of embodiment.

In FIGS. 3 to 6, parts and elements that are identical or equivalent to the parts and elements already described with reference to FIG. 1 (general structure of the cartridge 10) and to FIG. 2 (infusion chamber with the cartridge located inside it) are designated by the same reference numbers: the corresponding description is not repeated here so that the description of examples of embodiments will not be overburdened.

From a comparison between FIG. 3 with FIG. 2 (both of which regard the position of the cartridge 10 at the moment when the hot liquid and/or steam start/s to be introduced therein itself through the sealing foil 16 that has been perforated by the tips 104 when these are lowered) it may be appreciated that in FIG. 3 the entire bottom 142 of the cartridge 10—and in particular the portion 1420 that is subsequently to be perforated by the tips of the array 100—albeit facing the array of tips 100, is kept at a distance from this array (for example, by the values indicated previously).

FIG. 3 consequently exemplifies a situation in which the entire bottom 142 is located, with respect to the plane of introduction of the hot liquid and/or steam (plane identified by the foil 16), at a distance less than the height h of the infusion chamber.

From a comparison of FIG. 2 with FIG. 5 (both figures regard the conditions of insertion of the cartridge 10 into the infusion chamber at the moment when the hot liquid and/or steam start/s to be introduced into the cartridge 10 itself through the sealing foil 16), it may in a similar way be noted that, even in the presence of identical or substantially identical conformations of parts:
in the solution illustrated in FIG. 2, the bottom wall 142, and in particular the portion 1420 that is to be perforated, is located right from the start in contact with the array of tips 100 or at least in the neighbourhood thereof (points designated by P);
in embodiments such as the one exemplified in FIG. 5, the bottom 142 of the cartridge 10—and in particular the portion 1420 that is subsequently to be perforated by the tips of the array 100—albeit facing the array of tips 100, is kept at a distance from this array (for example, by the values indicated previously).

In the embodiments exemplified in FIGS. 3 to 6, only subsequently, i.e., following upon introduction of hot liquid and/or steam starting from the plane of lie of the foil 16, does the bottom 142 undergo plastic deformation (see FIGS. 4 and 6), coming into contact with the array of tips 100 so that the portion 1420 can be perforated by the aforesaid tips.

In the embodiments exemplified in FIGS. 3 to 6, this may occur as a result of the plastic deformation induced by the hot liquid and/or steam introduced into the cartridge 10, with the bottom wall 142 that comes into contact with the array of tips 100 and is subsequently “extruded” against them being perforated thereby so as to bring about exit of the beverage thus prepared from the cartridge 10 (for example, via the axial cavities of the tips of the array 100).

The duration of the interval or delay between when the hot liquid and/or steam start/s to be introduced into the cartridge 10 (i.e., the start of the action of introduction of the hot liquid and/or steam into the cartridge) and when the bottom wall 142 comes into contact with the array of tips 100 (following upon the plastic deformation induced by the hot liquid and/or steam introduced into the cartridge 10) determines the duration of the step of pre-infusion described previously.

In this regard, it will be appreciated that, all other parameters being equal, in the embodiments such as the ones exemplified in FIGS. 5 and 6 (with the bottom 142 concave), the duration of the step of pre-infusion may be different from (e.g., longer than) the duration of the step of pre-infusion in embodiments such as the ones exemplified in FIGS. 3 and 4 (with the bottom 142 substantially plane).

The deformation run (and hence the corresponding extent of deformation) that the bottom 142 is required to make to come into contact with the array of tips 100 may in fact be greater in the case of the concave bottom of FIGS. 5 and 6 than in the case of the plane bottom of FIGS. 3 and 4.

The choice of one conformation or the other (plane bottom, concave bottom) may hence constitute, possibly together with other parameters (materials, dimensions, etc.) a factor such as to enable adjustment of the duration of the pre-infusion step, for example as a function of the characteristics of the substance constituting the dose 12 (e.g., as a function of the mixture of coffee contained in the cartridge 10).

The conditions exemplified in FIGS. 3 and 5—cartridge 10 ready for start of the step of introduction of the hot liquid and/or steam with the bottom 142 kept at a certain distance from the array of tips 100—is suited to being implemented in at least two different ways (possibly combined together).

A first way regards the fact that the cartridge 10 may be used together with machines for preparing beverages of a certain type and model, already available on the market and/or already available to the user.

These are hence machines of a certain well-defined type and model, originally designed to be used with a given type of cartridge and hence equipped with infusion assemblies for which the height h of the infusion chamber, i.e., the distance that at the start of introduction of the hot liquid and/or steam separates the foil 16 from the array of the perforating tips 100, is known and determined (the position of the plane of the foil is known in so far as it is identified by the position of the means 200 for supporting the cartridge 10).

In the currently most widespread types of coffee-making machines, the infusion chamber (as defined herein) may have a height h ranging from 15 mm to 35 mm.

In this case, the criteria of use described above can be satisfied using cartridges 10 with a height d, measured between the sealing foil 16 and the perforable portion 1420 of the bottom 142, less than the height h of the infusion chamber, and hence, with reference to the values indicated above for the height h, values of the height d ranging from 17 mm to 26 mm.

In this way, the cartridge 10 can be located in the infusion chamber with the bottom 142 (perforable portion 1420) kept facing the array of tips 100 but at a distance therefrom, and is thus in a condition to come into contact with the array of tips 100 merely as a result of the deformation induced by the hot liquid and/or steam introduced into the cartridge.

A second way to satisfy the criteria of use described above may regard the possible use of pre-existing cartridges 10 via machines provided with an infusion assembly in which the means 200 for supporting the cartridge 10 are positioned (or, more in general, positionable, since the aforesaid elements may be mobile during introduction of the cartridge, as explained at the start of this detailed description) so as to support the cartridge 10 with the bottom 142 set at a distance from the array of tips 100, once again envisaging that the bottom 142 (perforable portion 1420) comes into contact with the array of tips 100 merely as a result of the deformation induced by the hot liquid and/or steam introduced into the cartridge 10.

In this case, the criteria of use described above can be satisfied by using machines, i.e., infusion assemblies with supporting means such as for example the one designated by 200, in which the height h of the infusion chamber is such that the height d of the cartridge 10, measured between the sealing foil 16 and the bottom 142 (perforable portion 1420), is less than the height h of the infusion chamber.

In this way, the cartridge 10 can be located in the infusion chamber with the bottom 142 (perforable portion 1420) at a distance from the array of tips 100, and is thus in a condition to come into contact with the array of tips 100 merely as a result of the deformation induced by the hot liquid and/or steam introduced into the cartridge.

FIG. 7 illustrates an example of structure of machines for preparing beverages according to embodiments.

In the example of FIG. 7, the reference number designates as a whole the infusion assembly comprising the infusion chamber, in which there can be inserted, according to the modalities described previously, the cartridge 10 from which the beverage (for example, coffee) exits and is collected in a container such as a cup C.

The liquid (typically water) that is to be heated for production of the beverage is contained in a tank T, from which it is pumped via a pump P to be sent on to a boiler W, possibly in view also of the generation of steam.

The steam possibly generated can be delivered outwards via a nozzle S controlled by a tap R.

The hot liquid and/or steam are/is sent to the infusion chamber 20 through a pressure-modulation valve V that can be calibrated, for example at values (2-12 bar; 5-8 bar) already mentioned previously. In one or more embodiments, the valve V may be substantially of the type described in WO-A-2013/014618.

The reference D indicates the possible presence of a drawer for collecting the spent cartridges.

Without prejudice to the principle of the invention, the embodiments and the details of construction may vary, even significantly, with respect to what has been illustrated herein purely by way of non-limiting example, without thereby departing from the sphere of protection. The sphere of protection is defined by the annexed claims.

1. A method of preparing a liquid product by means of heated liquid and/or steam introduced into a cartridge containing a filling of at least one substance for the preparation of said liquid product, the method including introducing said heated liquid and/or steam into the cartridge by producing deformation of a bottom of the cartridge and perforation of said bottom by an array of perforation tips facing said bottom,
wherein it includes arranging the cartridge with said bottom facing said array of perforation tips at a distance from said array of perforation tips, whereby contact of said bottom with said array of perforation tips due to deformation produced by said heated liquid and/or steam introduced into the cartridge takes place with a delay with respect to the beginning of the action of introducing of said heated liquid and/or steam into the cartridge.

2. The method of claim 1, including arranging the cartridge with said bottom facing said array of perforation tips at a distance of 1-6 mm, preferably 2-4 mm, from said array of perforation tips.

3. The method of claim 1, including introducing said heated liquid and/or steam into the cartridge at a pressure of 2-12 bar, preferably 5-8 bar.

4. The method of claim 1, including producing said bottom of the cartridge of a material plastically deformable without break in the temperature range 70° C.-200° C., preferably 70° C.-150° C.

5. An infusion assembly for the preparation of a liquid product by means of heated liquid and/or steam introduced into a cartridge containing a filling of at least one substance for the preparation of said liquid product, the infusion assembly including:
a supply line for feeding heated liquid and/or steam towards the cartridge,
an array of perforation tips for perforating a bottom of the cartridge due to deformation produced by said heated liquid and/or steam introduced into the cartridge, and
a support member for supporting the cartridge with said bottom facing said array of perforation tips,
characterized in that:
said supply line is configured, preferably with the interposition of a pressure modulation valve, for feeding said heated liquid and/or steam towards the cartridge with a pressure controlled in a pressure range,
said support member is positionable with respect to said array of perforation tips to support the cartridge at the beginning of the action of introducing of said heated liquid and/or steam into the cartridge with said bottom facing said array of perforation tips at a distance from said array of perforation tips.

6. The infusion assembly of claim 5, having at least one of the following characteristics:
said pressure range is 2-12 bar, preferably 5-8 bar;
said distance is 1-6 mm, preferably 2-4 mm.

7. A cartridge containing a filling of at least one substance for the preparation of a liquid product by means of heated liquid and/or steam introduced into the cartridge with the cartridge maintained in an infusion chamber having a height between a plane of introduction of the heated liquid and/or steam into the cartridge and an array of perforation tips for perforating a bottom of the cartridge wherein the cartridge includes:
a casing containing said filling with a side wall, a bottom and a sealing foil which closes the casing of the cartridge at an end opposite said bottom,
wherein the cartridge has a height, measured between said sealing foil and said bottom, smaller than said height of the infusion chamber, whereby the cartridge is locatable in said infusion chamber with said bottom facing said array of perforation tips at distance from said array of perforation tips whereby said bottom contacts said array of perforation tips only by deformation produced by said heated liquid and/or steam introduced into the cartridge.

8. The cartridge of claim 7, wherein the bottom of the cartridge includes a material plastically deformable without break in the temperature range 70° C.-200° C., preferably 70° C.-150° C.

9. The cartridge of claim 7, wherein said bottom has a thickness between 50 and 700 microns.

10. The cartridge of claim 7, wherein said height measured between said sealing foil and said bottom is 17-26 mm.
